(19) United States
(12) Patent Application Publication
(10) Pub. No.: US 2010/0169508 A1
(43) Pub. Date: Jul. 1, 2010

(54) Method for Controlling Heterogeneous iNIC Devices and Device Using the Same

(76) Inventors: Shih-Ching Jung, Hsinchu City (TW); Hsi-Kun Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/478,768

(22) Filed: Jun. 5, 2009

(30) Foreign Application Priority Data
Dec. 31, 2008 (TW) 097151617

(51) Int. Cl. G06F 15/16

(52) U.S. Cl. 709/250; 709/238

(57) ABSTRACT

A device for controlling heterogeneous iNIC (intelligent Network Interface Card) devices is disclosed. The device includes a physical network interface and a virtual device generation unit. The physical network interface connects with a plurality of iNIC devices via a packet switch. The virtual device generation unit is utilized for forming a plurality of virtual devices, which are individually corresponding to the plurality of iNIC devices, to act as agents for the plurality of iNIC devices to communicate with the device. Moreover, the plurality of virtual devices converts an upper layer control command into a predefined packet format and transmits the converted packets to the plurality of iNIC devices, and on the other hand, filters out packets transmitted by the plurality of iNIC devices from data received by the physical network interface according to the predefined packet format.

### BACKGROUND OF THE INVENTION

1. Field of the Invention

The present invention relates to a method for controlling heterogeneous iNIC devices and a device using the same, and more particularly, to a device and related method for managing and controlling multiple heterogeneous iNIC devices via a single physical network interface.

2. Description of the Prior Art

As the network technology advances, different application means are realized through different wireless network devices such as Wi-Fi, WiMax, Ultra-Wideband (UWB) and Bluetooth. Due to the benefit of the computing power offload from the host, the Intelligent Network Interface Card (iNIC), i.e. SOC with CPU embedded, for example, is gaining popularity amongst the modern wireless IC design.

In general, SOC requires an embedded flash memory for storing the firmware. In other words, SOC is equivalent to a standalone operating system, which is difficult to control and manage. Consequently, the effort and cost increase exponentially when integrating several of the wireless devices mentioned above, such as a 2.4 GHz/5 GHz WiFi or WiFi/WiMax dual-mode Access Point (AP) router, or a consumer Bluetooth/UWB product, into a wireless network product.

Therefore, lowering the cost and the effort of integrating various wireless products is a critical issue for the industry.

### SUMMARY OF THE INVENTION

The present invention provides a device for controlling heterogeneous Intelligent Network Interface Card (iNIC) devices. The device comprises a physical layer interface, for connecting to a plurality of heterogeneous iNIC devices via a packet switch; and a virtual device generation unit, for forming a plurality of virtual devices, individually corresponding to the plurality of heterogeneous iNIC devices, for acting as agents for the plurality of heterogeneous iNIC devices to communicate with the device; wherein the plurality of virtual devices converts an upper layer control command into packets with a predefined packet format and transmits the converted packets to the plurality of iNIC devices through the physical layer interface, and on the other hand, filters out packets transmitted by the plurality of iNIC devices from those received by the physical network interface according to the predefined packet format.

The present invention further provides a method for controlling heterogeneous Intelligent Network Interface Card (iNIC) devices in a device; the device comprises a physical layer interface connected to a plurality of heterogeneous iNIC devices via a packet switch. The method comprises forming a plurality of virtual devices, individually corresponding to the plurality of heterogeneous iNIC devices, for acting as agents for the plurality of heterogeneous iNIC devices to communicate with the device; converting an upper layer control command into packets with a predefined packet format and transmitting the converted packets to the plurality of heterogeneous iNIC devices through the physical layer interface by the plurality of virtual devices; and filtering out packets transmitted by the plurality of heterogeneous iNIC devices from those received by the physical layer interface according to the predefined packet format.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a device for controlling heterogeneous Intelligent Network Interface Card (iNIC) according to an embodiment of the present invention.

FIG. 2 is a flowchart of a process for controlling multiple heterogeneous iNIC devices in a device according to an embodiment of the present invention.

### DETAILED DESCRIPTION

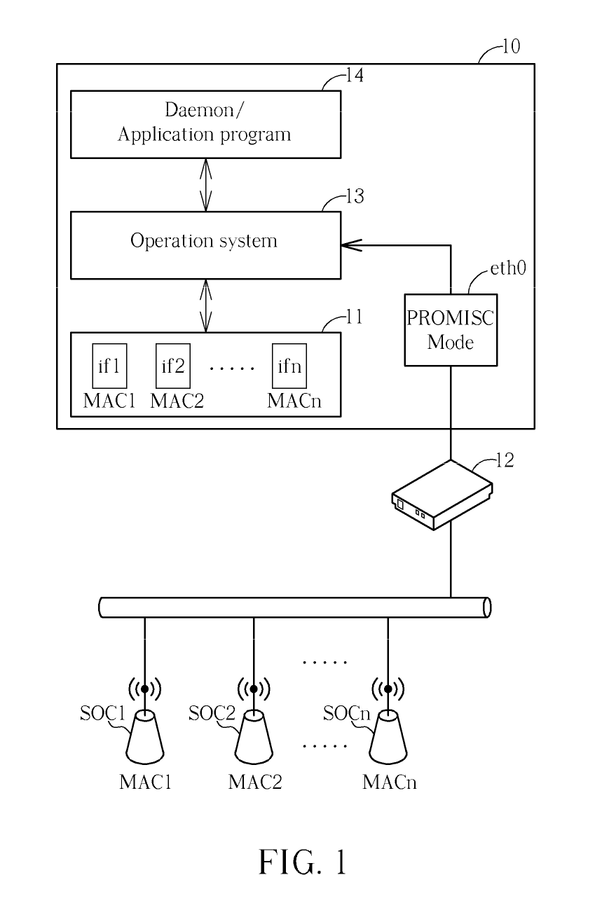

Please refer to FIG. 1. FIG. 1 is a schematic diagram of a device 10 for controlling heterogeneous Intelligent Network Interface Card (iNIC) according to an embodiment of the present invention. In the embodiment of the present invention, the iNIC device includes SOC with CPU embedded and can be any wired/wireless network devices such as WiFi or WiMax etc. The device 10 includes a physical interface eth0 and a virtual device generation unit 11. The physical interface eth0 is preferably an Ethernet interface, and is connected to iNIC devices SOC1˜SOCn via a packet switch 12; the virtual device generation unit 11 is preferably a driver program, and is utilized for forming virtual devices if1˜ifn individually corresponding to the iNIC devices SOC1˜SOCn. The virtual devices if1˜ifn individually act as an agent for the iNIC devices SOC1˜SOCn to communicate with the device 10. The iNIC devices SOC1˜SOCn also carries corresponding firmware for communicating with the virtual devices if1-ifn. Each of the virtual devices if1-ifn converts an upper layer control command into packets with a predefined packet format and transmits the converted packets to the iNIC devices SOC1-SOCn through the physical layer interface eth0, and on the other hand, filters out packets transmitted by the iNIC devices SOC1-SOCn from those received by the physical interface layer eth0 according to the predefined packet format.

According to the embodiment of the present invention, the device 10, i.e. a host side, utilizes the virtual devices if1-ifn for communicating with the iNIC devices SOC1-SOCn through the physical layer interface eth0, so as to process boot-up and control protocols between the device 10 and each of the iNIC devices. Therefore, the device 10 can control and manage multiple heterogeneous iNIC devices by a single physical network interface, and provides a transparent, hardware-independent interface to an upper layer daemon or application program 14. As a result, administration programs can be centralized in the device 10, instead of scattered in each of the iNIC devices SOC1-SOCn. The operation of the device 10 is further explained below.

As shown in FIG. 1, both of the virtual device interfaces if1-ifn and the iNIC devices SOC1-SOCn share the same physical addresses MAC1-MACn. In such a situation, the predefined packet format is a Layer 2 packet format with a header comprising a source address field, a destination address field and a type field. A type value of the type field is agreed on both iNIC firmware and host driver beforehand. Therefore, each virtual device can further generate a hook function in an operation system 13 of the device 10, for filtering out the packets transmitted by the iNIC devices SOC1-SOCn from those received by the physical layer interface eth0 according to the type value in headers of the packets. The hook function also dispatches the filtered packets to a corresponding virtual device according to destination addresses in headers of the packets.

Due to the source address learning feature in most of the modern switch design, a duplicate physical address on the host side and the iNIC device will lead to malfunction of the packet switch 12. In such circumstance, when the iNIC device, such as SOCn, transmits packets to the device 10, the physical address MACn in a multicast form, e.g. setting a least significant bit (LSB) of a first byte of the physical address MACn to 1, is inserted into the source address field of the packets, and the physical address MACn is inserted into the destination address field of the packets. Since the packet switch 12 does not learn a multicast physical address, the embodiment of the present invention is therefore able to maintain the switch function and MAC address identification at the same time.

From the view of the packet switch 12, the common source of the physical addresses MAC1-MACn is the same: the physical layer interface eth0. Therefore, all the packets with the destination addresses Mac1-MACn received by the packet switch 12 will be forwarded to the physical layer interface eth0. In other words, the embodiment of the present invention has to configure the physical layer interface eth0 to a PROMISC mode for receiving packets of any destination physical address, so as to utilize the hook function for dispatching the packets received by the physical layer interface eth0 to the corresponding virtual devices. As a result, the packets transmitted to the physical addresses MAC1-MACn can be forwarded to and processed by the virtual devices if1-ifn as the agents of the iNIC devices SOC1-SOCn.

On the other hand, since the physical addresses MAC1-MACn are considered located at the virtual devices if1-ifn, the packet switch 12 cannot forward uni-cast packets from the device 10 back to the corresponding iNIC devices SOC1-SOCn. Therefore, in the embodiment of the present invention, the physical layer interface eth0 sends the packets in multicast form (i.e. a multicast physical address is inserted into the destination address field of the packet header) to guarantee the transmitted packets can be received by the iNIC devices SOC1-SOCn. In this case, by checking the destination address in the packet header, e.g. comparing the physical address of the iNIC device with the destination address in the packet header other than the LSB of 1 st byte (i.e. multicast/broadcast bit), the iNIC devices SOC1-SOCn can then drop packets with any unmatched bits.

Although different iNIC devices can be identified by their own physical addresses, it is possible that no physical addresses are configured before the iNIC devices are booted up. According to the embodiment of the present invention, the host side can boot up one specific iNIC device within a same network segment at the same time via packet broadcasting. Therefore, after all the iNIC devices are one by one booted up to initialize their physical addresses, the device 10 can create the virtual devices if1˜ifn corresponding to each of the iNIC devices, so as to communicate with the iNIC devices SOC1-SOCn via the physical layer interface.

Subsequently, each of the virtual devices if1˜ifn is able to implement the following functions: uploads the firmware and other initial configurations to the corresponding iNIC devices; responds the Input/Output Control (IOCTL) requests from the operating system, the user space daemons and application programs for the iNIC devices; transmits or receives data packets for the user space daemons and application programs.

In the embodiment of the present invention, the upper layer control commands can be the IOCTL requests from the operating system, the user space daemons and application programs. Thus, the virtual devices if1˜ifn converts the IOCTL requests into packets with the predefined format and the packets are sent to the corresponding iNIC device via the physical layer interface. At the same time, the virtual devices will temporarily block the thread executing the IOCTL requests until an iNIC device response or a time out event is received.

Furthermore, in order to manage the iNIC devices, multiple daemons or application programs such as the wpa_supplicant or the Universal Plug and Play (UPnP) daemon, may be executed on the host side. Therefore, other than the IOCTL requests, the host side may also transmit/receive packets of other specific protocols such as the Extensible Authentication Protocol over LAN (EAPOL) to/from the virtual devices if1˜ifn. The virtual device if1˜ifn can then transmit the packets to the corresponding iNIC devices via the physical Ethernet interface. Similarly, responses of the transmitted packets are received by the physical Ethernet interface (which is configured in the PROMISC mode) and subsequently dispatched to the kernel or the upper layer daemon. Such variation also belongs to the scope of the present invention.

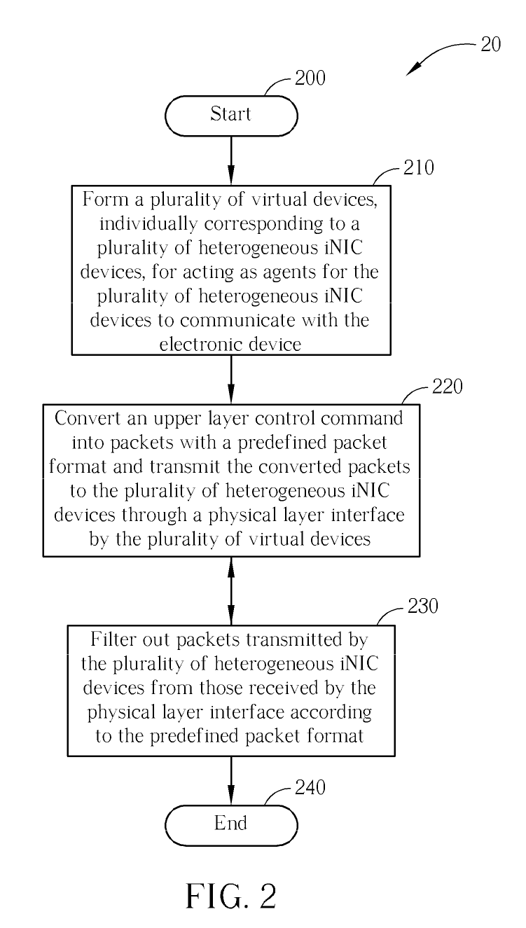

Please refer to FIG. 2. FIG. 2 is a flowchart of a process 20 for controlling multiple heterogeneous iNIC devices in a device according to an embodiment of the present invention. The process 20 is an operation process of the above device 10, and includes the following steps:

Step 200: Start.

Step 210: Form a plurality of virtual devices, individually corresponding to a plurality of heterogeneous iNIC devices, for acting as agents for the plurality of heterogeneous iNIC devices to communicate with the device.

Step 220: Convert an upper layer control command into packets with a predefined packet format and transmit the converted packets to the plurality of heterogeneous iNIC devices through a physical layer interface by the plurality of virtual devices.

Step 230: Filter out packets transmitted by the plurality of heterogeneous iNIC devices from those received by the physical layer interface according to the predefined packet format.

Step 240: End.

Step 220 and 230 can be repeated accordingly.

According to the process 20, the plurality of virtual devices converts the upper layer control command into packets with the predefined packet format and transmits the converted packets to the heterogeneous iNIC devices through the physical layer interface. On the other hand, the plurality of virtual devices also filters out the packets transmitted by the iNIC devices from those received by the physical layer interface. Therefore, the embodiment of the present invention can control and manage multiple heterogeneous iNIC devices by a single physical network interface, and provides a transparent, hardware-independent interface to the user-space daemon and application programs. The process 20 is described in the operational details of the above-mentioned device 10 and not narrated again herein.

In conclusion, the present invention utilizes the virtual devices to manage the boot and control protocol between the host side and each iNIC device. Furthermore, the present invention utilizes a single physical network interface to control and manage multiple heterogeneous iNIC devices, as well as providing a transparent, hardware-independent interface to the user-space daemon and application programs. As a result, the cost and effort for integrating various wireless applications can be greatly reduced.

Those skilled in the art will readily observe that numerous modifications and alterations of the device and method may be made while retaining the teachings of the invention.

What is claimed is:

1. A device for controlling heterogeneous Intelligent Network Interface Card (iNIC) devices, comprising:
a physical layer interface, for connecting to a plurality of heterogeneous iNIC devices via a packet switch; and
a virtual device generation unit, for forming a plurality of virtual devices, individually corresponding to the plurality of heterogeneous iNIC devices, for acting as agents for the plurality of heterogeneous iNIC devices to communicate with the device;
wherein the plurality of virtual devices converts an upper layer control command into packets with a predefined packet format and transmits the converted packets to the plurality of iNIC devices through the physical layer interface, and on the other hand, filters out packets transmitted by the plurality of iNIC devices from those received by the physical network interface according to the predefined packet format.

2. The device of claim 1, wherein the physical layer interface is a physical Ethernet interface.

3. The device of claim 1, wherein the predefined packet format is a layer 2 packet format with a header comprising a source address filed, a destination address field and a type field, wherein a type value of the type field is agreed on each of the plurality of heterogeneous iNIC devices and the device.

4. The device of claim 3, wherein each of the plurality of virtual devices generates a hook function in an operation system of the device for filtering out the packets transmitted by the plurality of heterogeneous iNIC devices from those received by the physical layer interface according to the predetermined packet format.

5. The device of claim 4, wherein the hook function filters out the packets transmitted by the plurality of heterogeneous iNIC devices from those received by the physical layer interface according to the type value in headers of the packets.

6. The device of claim 4, wherein the hook function dispatches the packets received by the physical layer interface to a corresponding virtual device of the plurality of virtual devices according to destination addresses in headers of the packets.

7. The device of claim 1, wherein the plurality of virtual devices individually has a same physical address as the plurality of heterogeneous iNIC devices.

8. The device of claim 7, wherein the physical layer interface is configured in a PROMISC mode.

9. The device of claim 7, wherein each of the packets transmitted to the device from each of the plurality of heterogeneous iNIC devices has a source address in a multicast form.

10. The device of claim 7, wherein each of the packets transmitted to each of the plurality of heterogeneous iNIC devices from the device has a destination address in a multicast form.

11. The device of claim 1, wherein the virtual device generation unit is a firmware or a driver program.

12. The device of claim 1, wherein each of the plurality of heterogeneous iNIC devices comprises a corresponding firmware, for processing the packets transmitted by the device.

13. The device of claim 12, wherein each of the plurality of heterogeneous iNIC devices further comprises a boot ROM, for starting a boot process according to the packets transmitted by the device.

14. A method for controlling heterogeneous Intelligent Network Interface Card (iNIC) devices in a device, the device comprises a physical layer interface connected to a plurality of heterogeneous iNIC devices via a packet switch, the method comprising:
forming a plurality of virtual devices, individually corresponding to the plurality of heterogeneous iNIC devices, for acting as agents for the plurality of heterogeneous iNIC devices to communicate with the device;
converting an upper layer control command into packets with a predefined packet format and transmitting the converted packets to the plurality of heterogeneous iNIC devices through the physical layer interface by the plurality of virtual devices; and
filtering out packets transmitted by the plurality of heterogeneous iNIC devices from those received by the physical layer interface according to the predefined packet format.

15. The method of claim 1, wherein the physical layer interface is a physical Ethernet interface.

16. The method of claim 14, wherein the predefined packet format is a layer 2 packet format with a header comprising a source address field, a destination address field and a type field, wherein the a type value of the type field is agreed on each of the plurality of heterogeneous iNIC devices and the device.

17. The method of claim 16, wherein each of the plurality of virtual devices generates a hook function in an operation system of the device, for filtering out packets transmitted by the plurality of heterogeneous iNIC devices from those received by the physical layer interface according to the predetermined packet format.

18. The method of claim 17, wherein the hook function filters out the packets transmitted by the plurality of heterogeneous iNIC devices from those received by the physical layer interface according to the type value in headers of the packets.

19. The method of claim 17, wherein the hook function dispatches the packets received by the physical layer interface to a corresponding virtual device of the plurality of virtual devices according to destination addresses in headers of the packets.

20. The method of claim 14, wherein the plurality of virtual devices individually has a same physical address as the plurality of heterogeneous iNIC devices.

21. The method of claim 20, further comprising:
configuring the physical layer interface to a PROMISC mode.

22. The method of claim 21, further comprising:
setting a source address of each of the packets transmitted to the device from each of the plurality of heterogeneous iNIC devices in a multicast form.

23. The method of claim 21, further comprising:
setting a destination address of each of the packets transmitted from the device to each of the plurality of heterogeneous iNIC devices in a multicast form.
